(19) United States
(12) Patent Application Publication
(10) Pub. No.: US 2019/0166242 A1
(43) Pub. Date: May 30, 2019

(54) CONTAINER, IN PARTICULAR FOR A DEVICE FOR PROTECTING AN ELECTRONIC APPARATUS, AND METHOD FOR MANUFACTURING SAID CONTAINER

(71) Applicant: ALBEA LE TREPORT, Le Treport (FR)

(72) Inventors: Pierre Gabriel Francis Dumont, Dargnies (FR); Mohamed Elmeguenni, Friville Escarbotin (FR); Emmanuel Huberdeau, Neuville-Les-Dieppe (FR); Thomas Pruvost, Saint-Quentin-La-Motte (FR)

(21) Appl. No.: 16/320,876

(22) PCT Filed: Jul. 24, 2017
(86) PCT No.: PCT/EP2017/068697

§ 371 Date: Jan. 25, 2019

(30) Foreign Application Priority Data
Jul. 25, 2016 (FR) 16 57092

(51) Int. Cl. H04M 1/21; H04M 1/18; B05B 11/00

(52) U.S. Cl. CPC H04M 1/21; A45C 2011/002; B05B 11/0037; H04M 1/185

(57) ABSTRACT

The invention relates to a container (3), in particular for a protective device for an electronic apparatus, the container (3) being provided with a reservoir (10) for a product, in particular a cosmetic product, the container (3) comprising two portions, a first attaching portion (39) provided with means (52) for attaching the container to a distinct object of the container, in particular to an element of the protective device, and a second support portion (42) that defines at least partially the volume of said reservoir (10), the attaching portion (39) and the support portion (42) being configured to be assembled to one another in such a way as to form said reservoir (10).

The invention relates to a container, in particular for a device for protecting an electronic apparatus. The invention also relates to a device for protecting an electronic device that comprises such a container. The invention further relates to a method of manufacturing said container.

In order to protect electronic devices such as mobile telephones or touch tablets, there are protections intended to surround them at least partially, and whose function is to prevent direct contacts with the device, for example in the case of a drop. Some protections consist in particular of casings made of a flexible material, such as rubber or leather, so as to be able to absorb impacts. On the other hand other protections are made from a rigid material that forms a shell, in order to act as a shield.

It was desired to add functionality to these protective devices, in order to render them more useful. Thus, certain protections have for example been designed to be able to transport everyday objects. In particular, certain protections are configured to be able to transport cosmetic product containers, such as perfume bottles. Patent application WO 2012/156546 is known for example, which discloses a protection provided with a lateral storage pocket making it possible to insert a perfume bottle therein.

Another document WO 2013/020591 relates to a shell comprising a removable bottle with a substantially planar shape, and arranged on the rear face of the shell. The shell is configured to receive the bottle in a reduced thickness of the shell. Thus, the bottle can be used, either in the stored position on the shell, or at a distance from the shell when it is manipulated. The shell comprises a storage space that maintains the bottle.

Another type of device simplifies the method of assembling the container to the shell. Thus, document EP 2 905 571 discloses a removable container provided with attachment means, which make it possible to directly assemble it onto the shell, without having to use a pocket for maintaining the container, wherein the insertion is difficult.

However, the manufacture of such a container requires great precision, in particular due to the attachment means which must be formed to precise dimensions, so that the method of attaching and detaching functions optimally. This problem is all the more present when the attachment means are small, with elements that are not very thick.

Indeed, deformable materials are used for this, for example of the thermo-polymer type, to manufacture at least the attachment means, and even generally the entire container. For the manufacture of the containers using materials of the thermoplastic type, a method, referred to as blow moulding or injection blow moulding, is often used. This method consists in injecting pressurised air in a heated preform arranged in a mould, in order to deform it to the dimensions of the mould, with this deformation giving the final form to the container.

Thus, today there is no method that makes it possible to obtain both a container and attachment means that are well defined. The invention aims at improving the situation by preventing the aforementioned defects, by supplying a container provided with attachment means.

For this, the invention relates to a container, in particular for a protective device for an electronic apparatus, the container being provided with a reservoir for a product, in particular a cosmetic product, the container comprising two portions, a first attaching portion provided with means for attaching the container to a distinct object of the container, in particular to an element of the protective device, and a second support portion that defines at least partially the volume of said reservoir, the attaching portion and the support portion being configured to be able to be assembled to one another in such a way as to form said reservoir.

Thus, thanks to the invention, the two portions can be formed separately, and then assembled in order to manufacture the container. This makes it possible in particular to manufacture the attaching portion with precise manufacturing methods so as to obtain attachment means that are well defined, that can in particular be of reduced dimensions. Implementing a single method to form the entire container, which renders such precision for the attachment means impossible to achieve, is thus avoided.

According to different embodiments of the invention, which can be taken together or separately:
the attaching portion is formed by injection,
the attaching portion is made from a thermoplastic material,
the support portion is formed by injection,
the support portion is made from a thermoplastic material,
the attaching portion and the support portion are assembled by ultrasound welding,
the attaching portion comprises a wall,
the wall is substantially planar,
the support portion has a form that defines a volume that forms at least partially said reservoir,
the support portion comprises an opening, in such a way that the volume defined by the support portion is open,
the wall of the attaching portion closes off the opening of the support portion, when the two portions are assembled,
the attaching portion comprises a first edge,
the attachment means comprise tabs arranged at a first edge of the wall of the attaching portion,
the attaching portion comprises a second edge opposite the first edge,
the attachment means are configured so that the container is removable,
the attachment means comprise a snap-fitting system arranged partially on the second edge of the wall, with the second edge being opposite the first,
the snap-fitting system comprises a snap-fitting notch arranged on the second edge of the wall,
the snap-fitting notch is intended to cooperate with a slot for receiving the snap-fitting notch arranged on the protective device,
the support portion has a parallelepiped shape,
the parallelepiped is rectangular,
the parallelepiped has a missing face so as to form the opening of the support portion,
the support portion is provided with a neck,
the pump is arranged on the container,
said pump can be operated by the actuating means,
the actuating means comprise a push-button in order to operate the pump,
the push-button is arranged on the pump,
the dimensions of the attaching wall are greater than the dimensions of the support portion,
at least one of the portions of the device, in particular the attaching portion, is made from a material of which the composition comprises Poly-Butadiene-Terephthalate, preferably mixed with Polyethylene Terephthalate.

The invention also relates to a device for protecting an electronic apparatus, in particular a mobile telephone, comprising a container according to the invention.

The invention further relates to a method for manufacturing a container provided with a reservoir, in particular for a cosmetic product, the method comprising the steps consisting of:
separately forming, an attaching portion provided with attachment means, and a support portion that defines at least partially the volume of said reservoir,
assembling the attaching portion and the support portion, in such a way as to produce the container, the assembly of the attaching portion and of the support portion forming the reservoir of the container.

The forming of at least the attaching portion is, preferably, carried out thanks to injection moulding. In addition, said moulding is done using a thermoplastic material. Furthermore, the thermoplastic material comprises Poly-Butadiene-Terephthalate, preferably mixed with Polyethylene Terephthalate.

The step of assembling the attaching portion and the support portion is preferably carried out via ultrasound welding.

The invention shall be better understood in light of the following description, which is provided solely for the purposes of information and does not intend to limit it, with reference to the attached drawings:

FIG. 1 diagrammatically shows a perspective view of a container according to an embodiment of the invention,

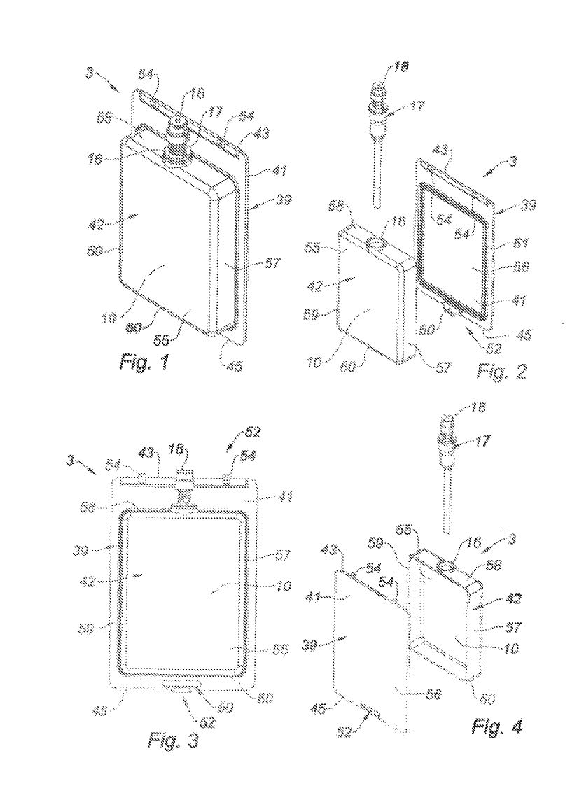

FIG. 2 diagrammatically shows a perspective view of the container of FIG. 1, of which the portions are separated,

FIG. 3 diagrammatically shows a front view of the container of FIG. 1,

FIG. 4 diagrammatically shows a perspective view of the container of FIG. 1, according to another angle of view, and of which the portions are separated,

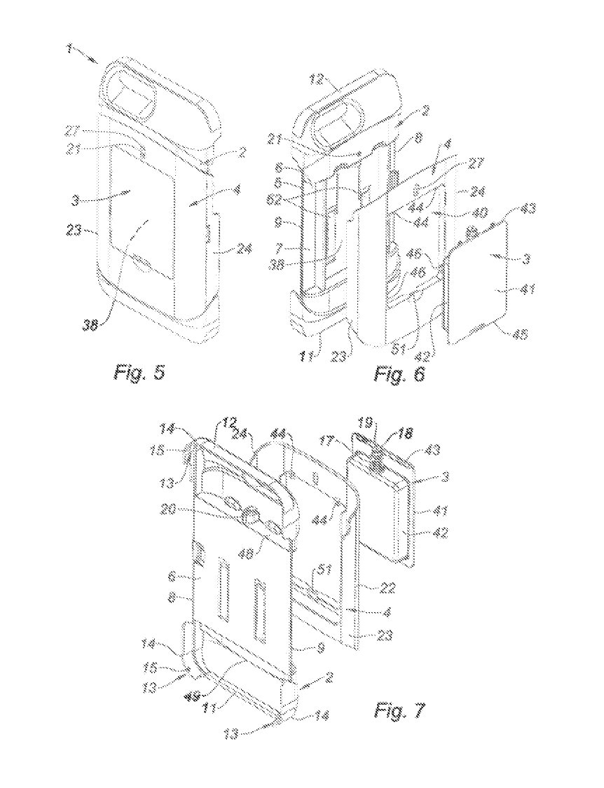

FIG. 5 diagrammatically shows a perspective view of a protective device for an electronic apparatus, the device comprising a container according to the invention,

FIG. 6 diagrammatically shows a perspective view of the protective device of FIG. 5, of which the portions are separated,

FIG. 7 diagrammatically shows a perspective view, according to another angle of view, of the protective device of FIG. 5, of which the portions are separated,

The invention relates to a container 3 provided with a reservoir 10 for a product, for example for a cosmetic or pharmaceutical product, with the product not being shown in the figures. In the embodiment shown in the figures, this is a bottle for a cosmetic product that is part of a protective device 1 for an electronic apparatus, comprising for example a mobile telephone shell. The container 3 is configured to be able to be fixed to an element of the device 1, here in a removable manner. Thus, the container 3 is fixed to the rest of the protective device 1 for the storage and the utilisation thereof, and to be separated therefrom, for example to fill it with a product or to change the container of the device 1.

The container 3 is provided with a neck 16 open on the reservoir 10, and with a pump 17 for suctioning the product that is located in the reservoir 10. The pump 17 is here a conventional manual pump arranged in the reservoir of the container 3 fixed to the neck 16 in a sealed manner. Such a pump 17 is for example formed of a movable piston chamber, a tube plunger arranged in the reservoir 10 for suctioning the product, and an outlet duct which conveys the product out of the pump 17. The outlet duct is integral with the piston, in such a way that the piston is actuated in the chamber following the displacement of the outlet duct.

The pump 17 can be operated using the actuating means, which are here provided with a push-button 18 arranged on the outlet duct, and with a helical return spring of the push-button 18 arranged around the outlet duct. Thus, pressing on the push-button 18 induces the displacement of the outlet duct and the actuating of the piston in the chamber in order to force the extraction of the product that is present in the chamber. After the actuating thereof, the push-button 18 returns to its initial position thanks to the spring. The push-button 18 is in addition provided with an outlet orifice 19 in communication with the outlet duct in order to allow for the passage of the product outside the pump, from the chamber, towards the outlet duct, and finally through the push-button 18.

As shown in FIGS. 1 to 4, the reservoir 10 of the container 3 here has a substantially rectangular parallelepiped shape. The parallelepiped has two large substantially parallel faces 55, 56 and four smaller faces 57, 58, 59, 60 perpendicular to the large faces 55, 56, and which connect the two large faces in order to close the reservoir 10. The neck 16 of the container 3 is arranged on one of the small faces.

According to the invention, the container 3 comprises two portions, a first attaching portion 39 and a second support portion 42. The support portion 42 defines at least partially the interior volume of said reservoir 10, while the attaching portion 39 is provided with attachment means 52 the container 3 to a distinct object of the container 3, here the protective device 1.

The support portion 42 is formed from certain faces of the parallelepiped. It comprises in this example all of the faces of the parallelepiped, except one of the large faces 56. In other words, the support portion 42 has the shape of a receptacle or box open on five faces, of which one large face 55 is the bottom of the receptacle, with four peripheral faces 57, 58, 59, 60 substantially perpendicular to said bottom. The support portion 42 therefore has an opening, in such a way that the volume defined by the support portion 42 is open. The support portion 42 has, in this embodiment, a shape that defines a volume that corresponds to the volume of said reservoir 10. In other words, the open volume of the support portion 42 here defines the interior volume of the reservoir 10. The support portion 42 is furthermore provided with said neck 16 on one of the peripheral faces 58.

According to the invention, the attaching portion 39 and the support portion 42 are configured to be able to be assembled to one another in such a way as to form said reservoir 10.

For this, the attaching portion 39 comprises a substantially planar wall 41 that can close off the opening of the support portion 42, when the two portions 39, 42 are assembled. Thus, the wall 41 forms, at least partially, a large face 56 of the parallelepiped, which is missing on the support portion 42.

For the assembly, the wall 41 comprises a groove for receiving 61 the support portion 42. The groove 61 defines a substantially rectangular shape on a face of the wall 41. The shape of the groove 61 corresponds to the dimensions of the support portion 42. Thus, the contour of the opening of the support portion 42 is inserted in the groove 61 during the assembly of the two portions 39, 41. The groove 61 improves the resistance of the assembly between the two portions 39, 41, and also facilitates the positioning of the portions between them during the assembly.

Furthermore, the attaching portion 39 comprises attachment means 52 configured to cooperate with the protective device 1 in order to allow for a removable fastening of the container 3 on the device 1. The attachment means 52 are arranged preferably on the wall 41. The dimensions of the wall 41 of the attaching portion 52 are greater than the dimensions of the support portion 42. Thus, the attachment means 52 extend beyond the dimensions of the support portion in order to be able to be used easily.

The attachment means 52 here comprise two tabs 54 arranged at a first edge 43 of the wall 41. The tabs 54 extend outside the perimeter of the wall 41 and parallel to the plane that it defines. The tabs 54 are arranged at a short distance from the corners of the first edge 43 of the wall 41. The tabs 54 have for function to retain the wall 41, when the container 3 is fixed to the rest of the device 1. The tabs 54 are slid under an edge of the device 1 in order to retain the first edge 43 of the wall 41 against this edge.

The attachment means 52 also comprise a snap-fitting notch 50 arranged at a second edge 45 of the wall 41. The snap-fitting notch 50 is part of a snap-fitting system, described hereinafter in the description, and which makes it possible to block the container on the protective device.

Concerning the manufacture of the container 3, the method comprises at least two consecutive steps.

The first step consists in forming separately, the attaching portion 39 and the support portion 42. The formation is preferably carried out by injection moulding, which is a technology that provides great precision of the moulded object. Said attaching portion 39 and the support portion 42 are preferably made from the same thermoplastic material, which is usual for injection moulding.

A composition of plastic material is for example used comprising mostly PBT (Poly-Butadiene-Terephthalate) for at least 80%, even 90% of the composition. PBT has the advantage of having good chemical resistance, resistance to impacts, an interesting surface aspect, shape memory, and furthermore prevents shrinkage cavities. The composition also comprises an additive, such as PET (Polyethylene Terephthalate), in proportions from 5% to 10% of the composition. A flame retardant can still be added to the composition, such as a mixture based on an organic phosphoric acid metal salt.

Parts are thus obtained of which the aspect is improved in addition to featuring an excellent shine, as well as greater facility in being decorated and in resisting scratches. Thanks to this composition, it is possible to produce the attaching portion and the support portion from a single thermoplastic material, this in order to obtain homogeneity in the aspect.

This material provides accumulated performance of each one of the components, such as the compatibility with the perfume containing at least 80% ethanol, a low coefficient of friction between two parts of the same material, compatibility with an anti-UV additive in order to stabilise the light ageing of the colours, an elasticity modulus at least equal to 2000 MPa for the shape memory, the ability to be welded using ultrasound welding in a sealed manner. The base material has a transparent, translucent or white colour, which facilitates decoration, for example by pad-printing or screen printing, and which can in addition be metallised and galvanised.

This composition therefore makes it possible to improve the characteristics of a material of which the cost of supply and of implementing is much less than that of fluoro-polymers, which are currently used for this purpose. In addition, the presence of fluorine is avoided, which is suspected to be harmful to human health.

The second step of the method consists in then assembling the attaching portion 39 and the support portion 42, in such a way as to form the container 3, so that the assembly of the attaching portion 39 and of the support portion 42 forms the reservoir 10 of the container 3. The assembly is preferably obtained by ultrasound welding. Such a technology makes it possible in particular to durably assemble plastic materials. Indeed, the portions 39, 42 are maintained together by the exercise of a mechanical pressure, while the plastic is heated at the juncture between the two portions to its melting point thanks to ultrasounds emitted for example by using an ultrasound probe. Thus, the melted materials of the two portions 39, 42 are mixed together. After cooling, the juncture hardens and the two portions 39, 42 are durably fastened to one another.

FIGS. 5 to 7 show a protective device 1, here for a mobile telephone, the device 1 having here a passage for the camera lens of the telephone. The device 1 comprises a protective casing 2 able to be fixed to the electronic device for the purpose of protecting it in case of an impact or fall. The protective casing 2 here comprises a shell, more preferably made from a rigid material for optimum protection. The shell is provided with a main wall 6 that forms the bottom of the casing 2, the main wall 6 comprising two longitudinal edges 8, 9 and two transversal edges 11, 12. The wall 6 also has an inner face 5 close to which the electronic device is intended to be positioned when the casing 2 is fixed to the device, and an outer face 7 opposite the inner face 5.

In order to assemble the protective deice to the mobile telephone, the casing 2 comprises fastening means 13, which are more preferably removable, in such a way as to be able to remove the casing 2 from the electronic apparatus, for example in order to change the battery of the apparatus. The edges 11, 12 comprise the removable fastening means, which are here corner supports 14 formed in the corners of the edges 11, 12. Each corner support 14 is configured to retain a corner of the electronic device. For this, the corner supports 14 surround the corners of the device and are provided with lugs 15 that retain the electronic apparatus by squeezing it.

The device 1 further comprises a unit for dispensing a product, in particular a cosmetic product. The dispensing unit in particular comprises the container 3 provided with a reservoir 10 for the product and actuating means configured to dispense the product.

The dispensing unit also comprises a spray nozzle 20 of the product, provided with an evacuation hole 21 towards the outside of the container and of the protective device, the hole 21 being, preferably, on the side opposite that of the electronic apparatus. The nozzle 20 is in communication with the outlet orifice 19 of the push-button 18 so that the product passing through the push-button 18 is guided in the nozzle 20.

The dispensing unit is fastened to the casing 2 in such a way that the container 3 is mobile with respect to the casing 2, more preferably according to a degree of freedom that corresponds to that of the actuating of the pump. In other words, the container 3 is mobile according to a direction of displacement, the direction being more preferably that according to which the push-button 18 is moved in order to actuate the pump 17. This direction is thus directed according to the outlet duct of the pump.

For this purpose, the protective device comprises a support structure 4 for maintaining the container 3 to the casing 2. The structure 4 is here movably mounted on the casing 2, in order to allow for the displacement of the container 3. In other words, the structure 4 is integral with the container 3, and they are displaced together. In the embodiment shown in the figures, more preferably, the support structure 4 is acted upon in order to displace the container 3 with respect to the casing 2.

In the FIGS. 5 to 7, the support structure 4 comprises a movable cover 22 arranged on the protective casing 2. The cover 22 covers the outer face 7 of the main wall 6 of the shell. The cover 22 here has curved longitudinal sides 23, 24 that extend over the longitudinal edges 8, 9 of the main wall 6. The cover 22 also here comprises an opening 27 in order to allow for the passage of the product exiting from the nozzle 20, because in the embodiment shown, the cover 22 covers the nozzle 20 of the casing 2. According to other embodiments wherein the cover 22 does not cover the nozzle 20, such an opening is not necessary.

The curved edges 23, 24 are provided with grooves arranged to receive the longitudinal edges 8, 9 of the main face 6. In this way, the longitudinal edges 8, 9 can slide in the grooves so as to allow for the displacement of the cover 22 along the main wall 6, while remaining secured in the other directions. The cover 22 is linked to the main wall 6 of the shell thanks to the grooves, but it can be displaced with respect to the shell.

The device 1 is furthermore configured so that the displacement of the container 3 with respect to the casing 2 actuates the dispensing of the product. For this, the actuating means are fixed with respect to the protective casing during dispensing operations, while the container 3 follows the direction of displacement of the support structure 4. Thus, the support structure 4 and the reservoir of the container 3 are displaced together with respect to the casing 2 in the direction of the push-button 18, the latter remaining immobile. For this, the push-button is maintained by the shell of the casing 2, in particular in order to prevent it from being displaced in the same direction as the container 3. Consequently, the push-button 18 presses on the outlet duct 17, in such a way that the pump is actuated, which causes the dispensing of at least one portion of the product contained in the reservoir.

Furthermore, the container 3 is assembled to the support structure 4, here in a removable manner. For this, the device 1 here comprises an interlocking space 38 of the container 3, such as shown in FIG. 6. The interlocking space 38 is defined between the outer face 7 of the main wall 6 of the protective casing 2 and the cover 22 of the support structure 4, which is arranged for example at a distance substantially corresponding to the width of the container, so that the latter is entirely interlocked in the space 38.

The cover 22 of the support structure 4 is in addition open at its centre in order to allow for the insertion of the container 3 into the space 38. This opening 40 here has dimensions that are at least equal to those of the container 3, in order to facilitate the insertion thereof.

The first edge 43 of the wall 41 is intended to rest on first lugs 44 of the cover 22 extending in the opening 40. A second edge 45 opposite the first edge is intended to rest on second lugs 46 of the cover 22, which also extend in the opening 40.

The device comprises a snap-fitting system arranged partially on the second edge of the wall, with the second edge being opposite the first. The snap-fitting system is provided on the one hand with the snap-fitting notch 50 arranged on the second edge 45 of the wall 41, and a slot for receiving 51 the notch 50 arranged on the cover 22 at the opening 40. When the snap-fitting notch 50 is introduced into the slot 51, it is blocked. The notch 50 is in particular provided with a thickened edge at its free end. The thickened edge is retained by the slot when the notch 50 is inserted into the slot. In addition, the wall 41 comprises a through light which allows for the deformation of the second edge 45 at the snap-fitting notch 50, in such a way that the notch can be displaced in order to be able to withdraw it from the receiving slot 51, and thus be able to remove and separate the container 3 from the rest of the protective device, in particular from the support structure 4.

The outer face 7 of the main wall 6 is here provided with at least one leaf-spring 62, here two as shown in FIG. 6, in order to facilitate the withdrawal of the container outside of the interlocking space 38. Thus, when the container 3 is interlocked, it pushes back the leaf-springs 62, and remains in position thanks to the attachment means 52 of the container 3, which oppose the force exerted by the leaf-springs.

In this embodiment, the dispensing unit is separated in two, a first portion being arranged on the protective casing 2 and a second portion on the support structure 4. On the one hand, the nozzle 20 and the evacuation hole 21 are integrated into the protective casing 2, and on the other hand the container 4 is provided with the pump 17 and the push-button 18. Thus, when the container 4 is withdrawn from the interlocking space, the nozzle 20 and the evacuation hole 21 are separated from the rest of the dispensing unit.

The casing 2 further comprises a well 47 for receiving the push-button 18. Thus, when the container 3 is interlocked, the push-button 18 is introduced into the well 47. The receiving well 47 is arranged under the nozzle 20 in such a way that the product coming from the dispensing orifice 19 of the push-button 18 then passes in the nozzle 20. The edges 11, 12 of the protective casing 2 each have an overhanging wall 48, 49 in relation to the main wall 6, oriented towards the outer face 7. The overhanging walls 48, 49 longitudinally delimit the interlocking space 38, and are perpendicular to the curved edges of the cover 22. The well 47 and the nozzle 20 are formed on one of the overhanging walls, outside of the interlocking space 38, the well 47 being opened by this overhanging wall 48, towards the interlocking space 38.

1. A container, in particular for a protective device for an electronic apparatus, the container being provided with a reservoir for a product, in particular a cosmetic product, the container comprising two portions,
a first attaching portion provided with means for attaching the container to a distinct object of the container, in particular to an element of the protective device, and
a second support portion that defines at least partially the volume of said reservoir, the attaching portion and
the second support portion being configured to be assembled to one another in such a way as to form said reservoir.

2. The container according to claim 1, wherein the attachment means are configured so that the container is removable.

3. The container according to claim 1, wherein at least the attaching portion is formed via injection moulding.

4. The container according to claim 3, wherein at least the attaching portion is made of a thermoplastic injection.

5. The container according to claim 1, wherein the attaching portion and the support portion are assembled by ultrasound welding.

6. The container according to claim 1, wherein the attaching portion comprises a substantially planar wall.

7. The container according to claim 6, wherein the support portion comprises an opening in such a way that the volume defined by the support portion is open.

8. The container according to claim 7, wherein the wall of the attaching portion closes off the opening of the support portion, when the two portions are assembled.

9. The container according to claim 1, wherein the attachment means comprise tabs arranged on an edge of the wall of the attaching portion.

10. The container according to claim 1, wherein the attachment means comprise a snap-fitting system arranged partially on an edge of the wall.

11. A protective device for an electronic apparatus, in particular for a mobile telephone, comprising a container being provided with a reservoir for a product, in particular a cosmetic product, the container comprising two portions,
a first attaching portion provided with means for attaching the container to a distinct object of the container, in particular to an element of the protective device, and
a second support portion that defines at least partially the volume of said reservoir, the attaching portion and
the second support portion being configured to be assembled to one another in such a way as to form said reservoir.

12. A method for manufacturing a container (3) according to one of claims 1 to 10, the method comprising:
separately forming, an attaching portion provided with attachment means, and a support portion that defines at least partially the volume of said reservoir,
assembling the attaching portion and the support portion, so as to produce the container, the assembly of the attaching portion and of the support portion forming the reservoir of the container.

13. The method according to claim 12, wherein the assembly of the attaching portion and the support portion is carried out by ultrasound welding.
